(19) United States
(12) Patent Application Publication
(10) Pub. No.: US 2026/0019717 A1
(43) Pub. Date: Jan. 15, 2026

(54) DIRECT RAW BAYER IMAGE INPUT TO COMPUTE HARDWARE

(71) Applicant: Tesla, Inc., Austin, TX (US)

(72) Inventors: Hasan UNLU, Mountain View, CA (US); Ritvik RAWAT, Sunnyvale, CA (US); Srihari SADHU SAMPATHKUMAR, Palo Alto, CA (US)

(73) Assignee: Tesla, Inc., Austin, TX (US)

(21) Appl. No.: 19/258,662

(22) Filed: Jul. 2, 2025

Related U.S. Application Data
(60) Provisional application No. 63/669,063, filed on Jul. 9, 2024.

(51) Int. Cl. H04N 23/84; B60W 60/00; H04N 25/13; H04N 25/71

(52) U.S. Cl. CPC H04N 23/84; B60W 60/001; H04N 25/134; B60W 2420/403; H04N 25/71

(57) ABSTRACT

Embodiments include systems and methods for input of raw Bayer image input. The method includes obtaining input data including multiple data elements having a second bit-width exceeding the first bit-width. The method includes generating multiple sets of the input data, each set having a portion of the data elements of the input data, by convolving a various first predefined kernels with the input data, each of the various first predefined kernels corresponding to one of the sets. The method includes, for each set, generating multiple subsets of the set by convolving a plurality of second predefined kernels with the set, each of the second predefined kernels corresponding to one of the subsets. The method includes generating channels, each of which includes output data including one or more of the multiple subsets. The method can be performed by a circuit for a first bit width.

### CROSS REFERENCE TO RELATED APPLICATION

This application claims priority to U.S. Provisional Application No. 63/669,063, filed Jul. 9, 2024, which is incorporated herein by reference in its entirety and for all purposes.

### TECHNICAL FIELD

This disclosure relates generally to augmenting an effective number of bits for a hardware pipeline. For example, the bit augmentation can be realized for multiplier-accumulators in a machine learning implementation.

### BACKGROUND

Convolutional neural networks (CNNs) were one of the earliest and most significant type of machine learning network, especially in the domain of computer vision. In recent years, machine learning has undergone a meteoric rise, revolutionized industries, and reshaped the technological landscape. Breakthroughs in architecture methodologies, including deep learning, have led to unprecedented levels of performance in tasks such as image recognition/computer vision, natural language processing, and autonomous driving. However, the increased precision of such approaches can prove expensive in terms of power budgets, die area, and other design considerations.

Moreover, a product lifecycle for some goods, including graphics processing units (GPU), automobiles, robotics, and so forth, can span decades—several generations of algorithmic development. Even where such products include substantial computational headroom to support updated algorithms, the types of hardware accelerators used may evolve over time, leading to mismatches between a type of hardware in a deployed product and components that may be associated with an updated model. Improvements in the art are desired.

### SUMMARY

Image data may be received from an image sensor via a Bayer filter. The Bayer filter can provide color data for discrete pixels that may thereafter be processed to interpolate color data such that each pixel can be associated with interleaved color values (e.g., red, green, and blue, RGB). These interleaved color values are sometimes referred to as mosaic data. Some operations can operate on color channel data, such that it is useful to segregate the interleaved red, green, and blue values into separate data structures. This segregation is sometimes referred to as de-mosaicing. To recover (e.g., de-mosaic) color channel data, an array of one or more multiplier-accumulators (MACs) can convolve image data with predefined kernels to deplane multiple constituent planes, where “deplaning” refers to the generation of output data structures including constituent components an input data structure, and where the generated data structures are referred to as planes. The convolutions with predefined kernels can be performed according to one or more stages (e.g., a first stage to deplane four constituent planes for one plane, and a second stage to deplane eight planes, two from each of the four constituent planes). In some embodiments, color channel data can be generated from a combination of multiple of the various (e.g., eight) planes to generate bit-augmented color channel data. In some embodiments, one of the various (e.g., eight) planes can be provided, as color channel data, to another device.

A bit-augmented resolution may be provided according to an updated sensor or other component of an image pipeline. However, some operations can be performed using bit-widths wider than the fixed bit-width (referred to as bit-augmented data). For example, a data bus operatively coupled with the MAC can provide data at lower degrees of precision achievable by other circuit components. Such an approach can be applied to achieve increased precision from lower precision hardware components, or can be used in new designs.

Inclusion of lower bit-width data or other busses in new designs can reduce power consumption according to a reduced number of signal state transitions or reduced size and power of bus drivers. The lower bit-width can also reduce circuit area used for routing (or increase line-to-line spacing to improve signal integrity) and may reduce an interconnect density in multi-chip modules, or between functional blocks of a monolithic device. This reduction in power usage or circuit area can exceed the power usage or circuit area used by a MAC. Moreover, even where the inclusion of the MAC leads to a net increase in area or power, the MAC can be placed away from density-critical areas or thermal hot spots, leading to overall improvement to device thermals, die area or so forth. Further still, application of the techniques of the present disclosure can aid in the re-use of an existing computing device for higher precision data than originally intended. For example, many implementations of convolutional neural networks (CNNs) have been supplemented with higher resolution CNNs, transformer models, attention mechanisms, or other implementations that can use varying hardware resources or bit precision (e.g., lesser or greater precision, such as by replacing an 8-bit dataflow with a 12-bit or 16-bit data flow). Accordingly, compute devices tasked with implementing newer techniques may not only suffer from a lack of some hardware components, the compute devices can also include components that are underutilized according to updated models. In some embodiments, a method for arithmetic computation may include: obtaining, by a circuit having a maximum bit-width of a first bit-width, input data including a plurality of data elements having a second bit-width exceeding the first bit-width; generating, by the circuit, a plurality of sets of the input data having a portion of the data elements of the input data, by convolving a plurality of first predefined kernels with the input data, the plurality of first predefined kernels corresponding to the sets; for the sets, generating, by the circuit, a plurality of subsets of a corresponding set by convolving a plurality of second predefined kernels with the set, the plurality of second predefined kernels corresponding to the subsets; and generating a plurality of filtered elements, by the circuit, the filtered elements including output data including one or more of the plurality of subsets.

The plurality of filtered elements may include color channels of an image obtained according to a Bayer filter. The color channels may include a red channel, a blue channel, and a green channel. The image may be obtained from a camera of a vehicle autonomous driving system. The circuit may be configured to generate control signals to execute a navigational action based on information obtained via the color channels.

The method may further include providing, by the circuit to an output of a plurality of multiplier-accumulators (MACs), the color channels according to a bit width exceeding the first bit-width. The method may further include obtaining, by the circuit, an indication of an identity of one of an operating condition or a component at the output of the plurality of MACs; and selecting, by the circuit based on the identity, the bit width exceeding the first bit-width from a plurality of bit-widths, at least one of the plurality of bit-widths not exceeding the first bit-width.

A first set of the plurality of sets of the input data may include a first portion of a first data element, the first portion corresponding to a first of the plurality of filtered elements. A second set of the plurality of sets of the input data may include a second portion of the first data element. The first portion corresponding to the first of the plurality of filtered elements, neither of the first portion nor the second portion of the first data element exceeding the second bit-width. The second bit-width may exceed a sum of a third bit-width of the first portion of the first data element and a fourth bit-width of the second portion of the first data element.

The plurality of first predefined kernels and the plurality of second predefined kernels may be single-entry kernels. The plurality of sets may include sparse data structures. The plurality of sets may include a first set of four data structures generated according to a convolution of the input data with four two-by-two single-entry kernels with a stride of two. The plurality of subsets may include two data structures generated according to a convolution of a plurality of one-by-two single-entry kernels with the first set of four data structures.

The input data represents environmental information for a computer-vision system, and an output of the circuit is configured to generate control signals to execute a maneuver of a robotic system.

In some embodiments, a system for arithmetic computation, the system may include: a circuit for a first bit-width and configured to: obtain input data including a plurality of data elements having a second bit-width exceeding the first bit-width; generate a plurality of sets of the input data having a portion of the data elements of the input data, by convolving a plurality of first predefined kernels with the input data, the plurality of first predefined kernels corresponding to the sets; for the sets, generate a plurality of subsets of a corresponding set by convolving a plurality of second predefined kernels with the set, the plurality of second predefined kernels corresponding to the subsets; and generate a plurality of filtered elements including output data including one or more of the plurality of subsets.

The plurality of filtered channels may include color channels of an image. The circuit may be configured to obtain the image according to a Bayer filter. The color channels include a red channel, a blue channel, and a green channel. The circuit may be configured to: obtain the image from a camera of a vehicle autonomous driving system; and generate control signals to execute a navigational action based on information obtained via the color channels. The circuit may be configured to provide, to an output of a plurality of multiplier-accumulators (MACs), the color channels according to a bit-width exceeding the first bit-width.

The circuit may be configured to: obtain, by the circuit, an indication of an identity of one of an operating condition or a component at the output of the plurality of MACs; and select, by the circuit based on the identity, the bit-width exceeding the first bit-width from a plurality of bit-widths, at least one of the plurality of bit-widths not exceeding the first bit-width. A first set of the plurality of sets of the input data may include a first portion of a first data element. The first portion corresponding to a first of the plurality of filtered elements. A second set of the plurality of sets of the input data includes a second portion of the first data element. The first portion corresponding to the first of the plurality of filtered elements, neither of the first portion nor the second portion of the first data element exceeding the second bit-width. The second bit-width may exceed a sum of a third bit-width of the first portion of the first data element and a fourth bit-width of the second portion of the first data element.

The plurality of first predefined kernels and the plurality of second predefined kernels may be single-entry kernels. The plurality of sets may include sparse data structures.

In some embodiments, an autonomous vehicle may include one or more image sensors and a circuit. The one or more image sensors may be configured to generate an input data structure for image data, the input data structure having a plurality of data elements which exceed a first bit-width. The circuit having a maximum bit-width of a first bit-width may be configured to: obtain input data including the plurality of data elements having a second bit-width exceeding the first bit-width; generate a plurality of sets of the input data having a portion of the data elements of the input data, by convolving a plurality of first predefined kernels with the input data, the plurality of first predefined kernels corresponding to one of the sets; for the sets, generate a plurality of subsets of a corresponding set by convolving a plurality of second predefined kernels with the set, the plurality of second predefined kernels corresponding to the subsets; and generate a plurality of filtered elements including output data including one or more of the plurality of subsets.

The plurality of filtered elements may be color channels of an image. The autonomous vehicle may be configured to generate control signals to execute a navigational action based on information obtained via the color channels.

It is to be understood that both the foregoing general description and the following detailed description are exemplary and explanatory and are intended to provide further explanation of the invention as claimed.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled visual data analysis system for egos, according to an embodiment.

FIG. 1B illustrates various sensors associated with vehicle (or other type of ego), according to an embodiment.

FIG. 1C illustrates the components of an ego, according to an embodiment.

FIG. 1D shows certain hardware and software components of the ego for performing full or partial self-driving (SD) operations, according to an embodiment.

FIG. 2A illustrates an example of charge coupled device sensor data relative to an output derived therefrom, according to some embodiments.

FIG. 2B illustrates an example of red, green, and blue pixel data and convolutions associated therewith, according to some embodiments.

FIG. 2C illustrates an example data flow for an example data structure, according to some embodiments.

FIG. 2D illustrates another example data flow for an example data structure, according to some embodiments.

FIG. 3 illustrates an example flow diagram for a method of color channel extraction, according to some embodiments.

FIG. 4 illustrates an example flow diagram for a method of channel extraction, according to some embodiments.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Embodiments described herein include systems and methods related to bit augmented arithmetic convolution. A CNN can be executed according to many parallel multiplier-accumulators (MACs). However, when implemented in hardware, such as in the case of an application specific integrated circuit (ASIC), a MAC can include a predefined bit width, corresponding to a data path of a design architecture. Accordingly, it may be challenging to process higher resolution data than an ASIC was originally designed for. However, according to the present disclosure, convolutional processes (e.g., as those implemented by MAC blocks) can be used to generate updated data flows for higher resolution or other updated models. In some embodiments, the systems and methods disclosed herein can be implemented at a compiler or a low-level of a stack such that the particular hardware implementation may be realized transparently to a model or other application-level software. For example, the systems realized according to the present disclosure can operate at a precision, data throughput, or performance as hardware having a native bit-width equal to a bit-width of a model, even when some hardware components have a lower bit-width than the bit-width of the model.

More particularly, a bit-augmented input may be received from a charge coupled sensor (CCD) or other image source. For example, the bit-augmented input can be received from one or more color channels, such as one or more red, green, or blue channels of a CCD. The bit-augmented input refers to or includes an input having a greater bit-width than a hardware component, such as a twelve-bit input provided relative to one or more eight-bit MACs. For example, twelve-bit CCD data can be provided to multiple eight-bit MACs to process the data without a loss of precision of the four excess bits of the CCD data relative to the MAC. A series of convolutional operations can separate channel data for colors. A predefined data structure can correspond to a CCD. For example, a Bayer filter can detect color information according to a red channel, a blue channel, and two green channels (to roughly correspond to human perceptions of vision). An image signal processor (ISP) can use interpolation or other functions to generate an output image based on the channels (sometimes referred to as delayering or de-mosaicing). However, in some instances, an image signal processor may not be present, may not be configured to receive bit-augmented inputs, or generating a data path to provide data to the ISP may exceed an available bandwidth. Accordingly, other approaches may be used that can include convolutional segregation of color channels of an image.

Even where a sequence of operations includes separation of color channels according to a predefined data structure (e.g., a memory map corresponding to a CCD sensor), an arithmetic logic unit (ALU) including a shift register or other component to so separate the bit-augmented input may not be disposed proximal to other hardware. For example, deplaning the predefined data structure to generate channel information could saturate memory bandwidth transporting highly parallelized data to a limited number of ALUs, imposing latency so as to degrade a user experience. In some instances, such as for a perception unit of an autonomous driving system, the incurred latency can degrade system performance or even render a system inoperable. Accordingly, convolutional or other hardware (e.g., MACs) can be used for the deplane operations. For example, for color data that is between eight-bits and sixteen-bits (e.g., two-byte data), a first plane (including the MSB of a data array) can be generated according to an 8-bit 2×2 convolutional kernel having a stride length of 2. That is, a byte kernel of

$$[ \begin{matrix}1 & 0 \\ 0 & 0\end{matrix} ]$$

can sparsify a data structure to one plane (e.g., corresponding to a MSB of a red channel and a MSB of a first green channel). The deplaning operation can deplane a first portion, second portion, third portion, and fourth portion of the bit-augmented input. In some embodiments, the sparsified data structure can be output as non-sparse (e.g., according to a remapping of the data or pointers therefor).

Further convolutional kernels can generate further sparse outputs with other data of the bit-augmented input (e.g., other planes that may be de-scarified). To continue the example above, an 8-bit 1×2 convolutional kernel having a stride length of 2 can deplane the MSB of a red channel from the MSB of the first green channel (e.g., according to kernels of [0 1]; [1 0]). At an output of the channel, the MSB and LSB may be combined to form a bit-augmented channel, or an LSB can be omitted to provide lower precision non-augmented data, as may be useful for certain operations. For example, a model can be configured to operate in one of an augmented (e.g., high-precision) or non-augmented (e.g., standard-precision) output mode, or can include run-time switches to change therebetween.

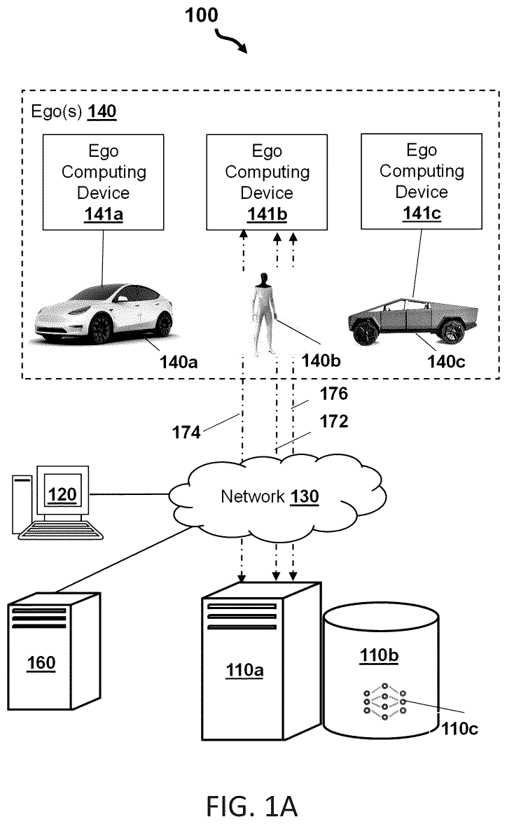

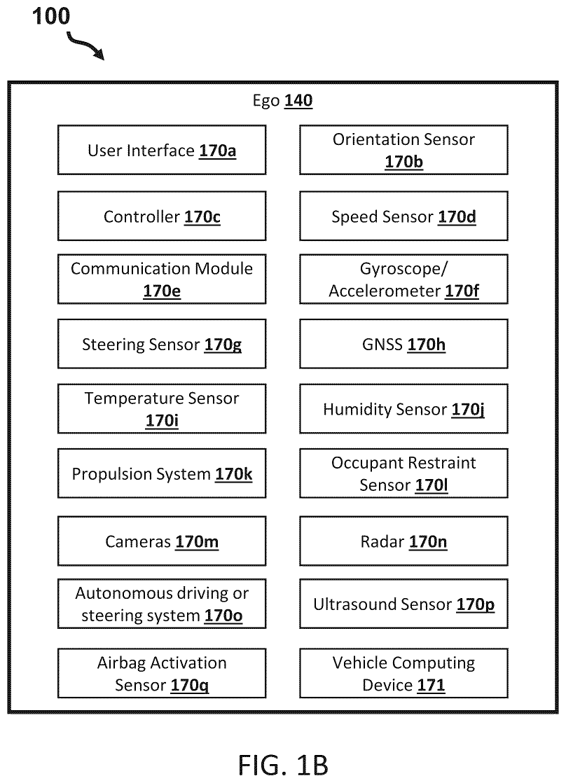

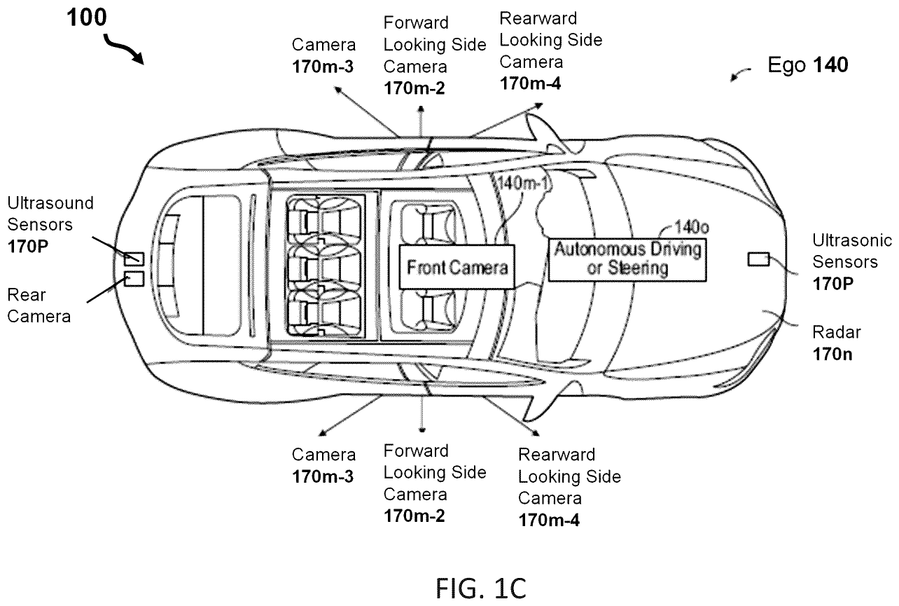

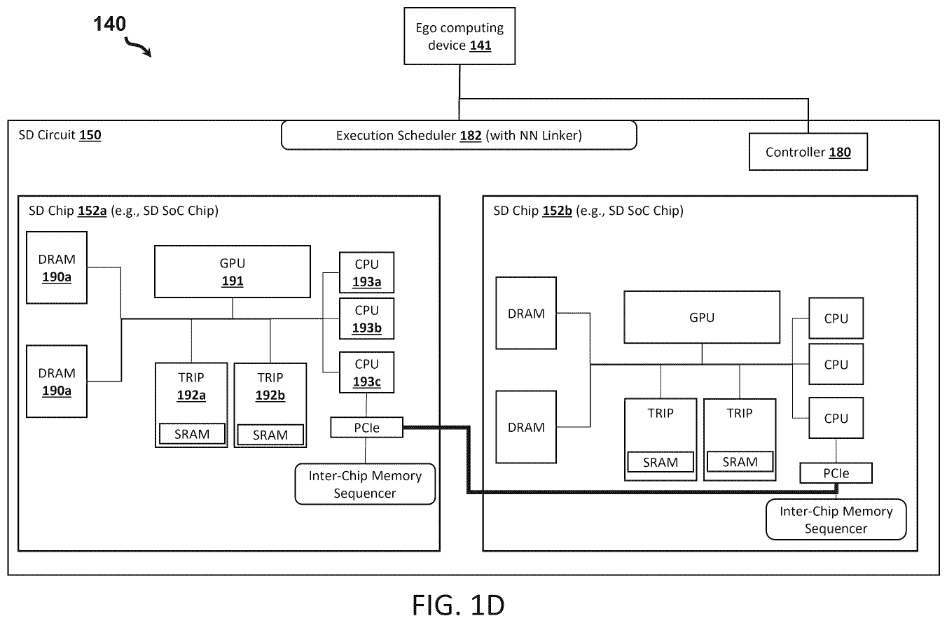

FIG. 1A is a non-limiting example of components of a system 100 in which the methods and systems discussed herein can be implemented. For instance, an analytics server may train an AI model and use the trained AI model to generate an occupancy dataset and/or map for one or more egos 140, which may implement embodiments for bit-augmented arithmetic convolution described herein. FIG. 1A illustrates components of an AI-enabled visual data analysis system 100. The system 100 may include an analytics server 110a, a system database 110b, an administrator computing device 120, egos 140a-140b (collectively ego(s) 140), ego computing devices 141a-141c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 mi, 100 ft) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-1C illustrate block diagrams of sensors integrated within the egos 140, according to an embodiment. The number and position of each sensor discussed with respect to FIGS. 1B-1C may depend on the type of ego 140 discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 170o). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-1C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model(s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A-1D (e.g., a processor of the egos 140).

The analytics server 110a may generate, using a sensor of an ego 140, a first dataset having a first set of data points where each data point within the first set of data points corresponds to a location and a sensor attribute of at least one voxel of space around the egos 140, the sensor attribute indicating whether the at least one voxel is occupied by an object having mass.

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

The analytics server 110a may generate a first dataset using the sensor data received from the one or more of the egos 140. The first dataset may indicate the occupancy status of different voxels within the surroundings of the one or more of the egos 140. As used herein in some embodiments, a voxel is a three-dimensional pixel, forming a building block of the surroundings of the one or more of the egos 140. Within the first dataset, each voxel may encapsulate sensor data indicating whether a mass was identified for that particular voxel. Mass, as used herein, may indicate or represent any object identified using the sensor. For instance, in some embodiments, the egos 140 may be equipped with an emitter that identifies a mass by emitting pulses and measuring the time it takes for these pulses to travel to an object (having mass) and back. These sensor systems may operate based on the principle of measuring the distance between the emitter/sensor and objects in its field of view. This information, combined with other sensor data, may be analyzed to identify and characterize different masses or objects within the surroundings of the one or more of the egos 140.

Various additional data may be used to indicate whether a voxel of the one or more egos' 140 surroundings is occupied by an object having mass or not. For instance, in some embodiments, a digital map of the surroundings (e.g., a digital map of the route being traversed by the ego) of the one or more egos 140 may be used to determine the occupancy status of each voxel.

In operation, as the one or more egos 140 navigate, their sensors collect data and transmit the data to the analytics server 110a, as depicted in the data stream 176. For instance, the ego 140 computing devices 141 may transmit sensor data to the analytics server 110a using the data stream 176.

The analytics server 110a may generate, using a camera of the ego 140, a second dataset having a second set of data points where each data point within the second set of data points corresponds to a location and an image attribute of at least one voxel of space around the ego 140.

The analytics server 110a may receive a camera feed of the one or more egos 140 navigating the same route as in the first step. In some embodiments, the analytics server 110a may simultaneously (or contemporaneously) perform the first step and the second step. Alternatively, two (or more) different egos 140 may navigate the same route where one ego transmits its sensor data, and the second ego 140 transmits its camera feed.

The one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates each data point within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar).

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

After the AI model 110c is trained, it can be used by an ego 140 to predict occupancy data of the one or more egos' 140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a trip) can then be fed back into the AI model(s) 110c, such that the additional data can improve the AI model(s) 110c.

FIG. 1D shows certain hardware and software components of the ego 140 for performing full or partial self-driving (SD) operations, according to an embodiment. The ego 140 comprises an SD circuit 150 and the ego computing device 141, which may include the same or different components of the SD circuit 150. The SD circuit 150 includes SD chips 152a-152b (generally referred to as SD chip 152), such as system-on-chip (SoC) integrated circuit chips. Each SD chip 152 includes non-transitory machine-readable memories, such as Dynamic Random Access Memories (DRAMs) 190a-190b (generally referred to as DRAMs 190) and SRAMs. The SD chip 152 further includes various types of processing units, including a GPU 191, central processing units (CPUs) 193a-193c (generally referred to as CPUs 193), and specially designed Tera-op, Reliable, Intelligently adaptive Processing System (TRIP) processing units 192a-192b (generally referred to as TRIP units 192).

As mentioned, the ego computing device 141 may execute various software programming operations for managing operations of the SD circuit 150 (or other hardware), which may include execution instructions for applying the neural network architecture on the types of sensor data from the sensors of the ego 140. The operations of the ego computing device 141 may further include, for example, compiling execution instructions for the SD circuit 150 to perform certain functions of the neural network architecture or for operating the ego 140.

In the example embodiment, the SD circuit 150 comprises two SD chips 152a-152b. In many cases, the SD chips 152 function in a redundancy mode or failover mode of operation, where a first SD chip 152a functions as a primary chip and a second SD chip 152b functions as a secondary chip. For example, the first SD chip 152a is prioritized to execute most of the executable instructions, and the second SD chip 152b is invoked to operate as failover or redundancy in the event of problems with the first SD chip 152a.

The ego 140, however, may comprise an SD circuit 150 that operates in an extended compute mode that balances the execution instruction pipelines amongst SD chips 152. As an example, the ego computing device 141 executes software routines for compiling the execution instructions to be performed by the processing units 191-193 of the SD chips 152 and distributing the execution instructions to the optimal hardware components of the SD circuit 150.

In some embodiments, the ego 140 comprises a controller 180 that performs various operations for managing the SD circuit 150. The controller 180 may perform various functions according to, for example, instructions from the ego computing device 141 (or other component of the ego 140) or configuration inputs from an administrative user. For instance, the controller 180 toggles, configures, or otherwise instructs the SD circuit 150 to operate in the various operational modes. In some circumstances, for example, the controller 180 instructs the SD circuit 150 to operate in an extended compute mode in which the first SD chip 152a executes a first instruction partition of the execution instructions and the second SD chip 152b executes a second instruction partition. As another example, in some circumstances, the controller 180 instructs the SD circuit 150 to operate in a failover mode in which the second SD chip 152b executes the execution instructions when the first SD chip 152a fails.

The SD chip 152 includes one or more DRAMs 190 or other types of non-transitory memories for storing data inputs for the SD chip 152. The data inputs may be stored in the DRAM 190 for the processing units to reference for various computations. In some configurations, the TRIP units 192 include SRAMs, such that the SD chip 152 moves the data from a DRAM 190 for storage into the SRAM of the TRIP unit 192. The TRIP unit 192 executes the computation according to the execution instructions and moves the data back to the DRAM 190 or other destination of the SD circuit 150.

The SD chip 152 includes various types of processing units, which may include any hardware integrated circuit (IC) processor device capable of performing the various processes and tasks described herein. Non-limiting examples of the types of processing units include GPUs 191, CPUs 193, TRIP units 192, microcontrollers, ALUs, ASICs, and FPGAs, among others. The processing units may perform the computational functions of the programming layers defining the neural network architectures or sub-architectures. The compilers output the execution instructions representing the operations of the neural network architecture, executed by the ego computing device 141 (or other component of the ego 140).

The TRIP units 192 are designed specifically for the neural network operations, beneficially focusing on improvements to, for example, optimizing power and performance (e.g., low latency). The TRIP units 192 include hardware IC devices (e.g., microcontrollers, ALUs, ASICs, FPGAs, processor devices) designed for fast operations when processing neural network architectures. For instance, as transformers and other types of neural network modeling techniques grow more popular, typical processing units (e.g., CPUs, GPUs) may be unnecessarily slow due to a theory of design intended for broader implementation use cases. For instance, a neural network architecture, sub-neural network, or child neural network performs computer vision or object recognition by implementing various GPTs (or other types of transforms) on the image sensor data, beneficially replacing previous techniques for post-processing of vision neural networks. The TRIP unit 192 is designed specifically for neural network operations allowing the GPT transformers to run natively in the computing components of the ego 140, such that the TRIP units 192 provide faster and more efficient processing than traditional GPUs 191 or CPUs 193 executing similar GPT transformations. In this way, the TRIP units 192 mitigates or eliminates latency and improves overall efficiency, contributing to the ability of the ego 140 to make real-time decisions. Moreover, the structural design and design theory of the TRIP units 192 draw comparatively less power than traditional GPUs 191 or CPUs 193 when performing more sophisticated and complex functions of neural network architectures, such as the transformer networks (e.g., transformers).

The ego computing device 141 may execute software programming defining an execution scheduler 182, which determines which component of the SD circuit 150 should execute which operations of the neural network architecture. During training or inference time, the ego computing device 141 extracts features or tensors from the input sensor data gathered from the sensors of the ego 140, which the ego computing device 141 feeds to the various neural network architecture or sub-architectures for various operations (e.g., computer vision, object recognition). The ego computing device 141 applies a graph partitioner on the sensor data to generate data partitions or portions. The ego computing device 141 applies a set of compilers (not shown), which may logically form a compiler toolchain for the neural network architecture of the ego 140, for compiling and debugging the code for executing layers of the neural network architecture for sensor-data interpretation. Each compiler is used to transform the high-level programming language into machine code comprising execution instructions, executed by the hardware of the SD circuit 150. The compilers may be configured or optimized to compile the programming code according to the specific architectures or types of the processing units (e.g., CPU 193, GPU 191, or specialized TRIP unit 192 hardware) of the SD chips 152. The linker of the execution scheduler 182 may combine multiple compiled pieces of code (e.g., executable instructions) into one or more executable files or data stream for an execution schedule (not shown).

The linker and execution scheduler 182 obtains the set of execution instructions and maps the execution instructions into the hardware components (e.g., GPUs 191, TRIP units 192, CPUs 193) of the SD circuit 150 to perform the particular execution instructions. In some implementations, the linker of the execution scheduler 182 is trained to optimize the operations to be performed in the hardware components of the SD circuit 150. The linker is trained to determine or preconfigured with temporal or latency demands for the hardware components to perform the operations of the execution instructions. This is often possible because such performance-timing or latency metrics are known, essentially static, quickly calculated, or prestored. In this way, the linker maps the execution instructions to the components of the SD circuit 150 according to the minimized or optimized latency. Additionally or alternatively, the linker determines which hardware components of the SD circuit 150 should perform which execution instructions based upon characteristics of the execution instructions (e.g., which compiler generated the machine code of the execution instruction). In this way, the linker maps the execution instructions to the processing units based upon the compiler that generated the particular execution instruction.

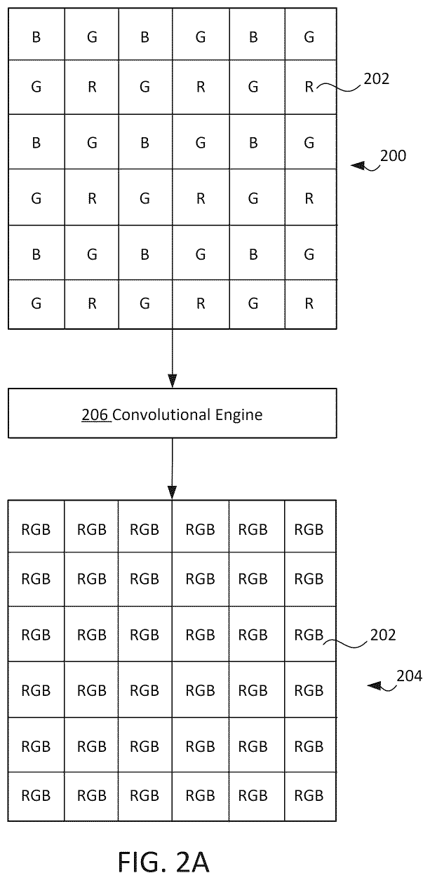

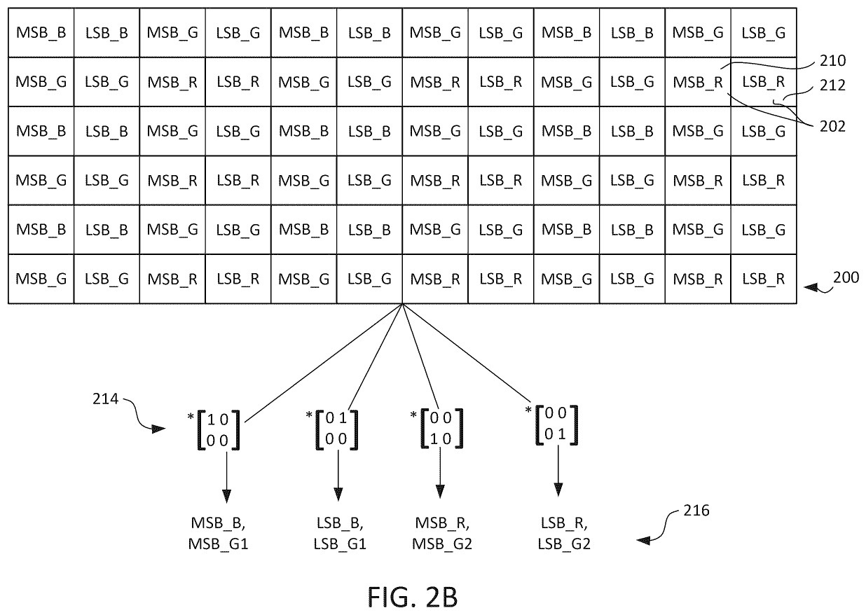

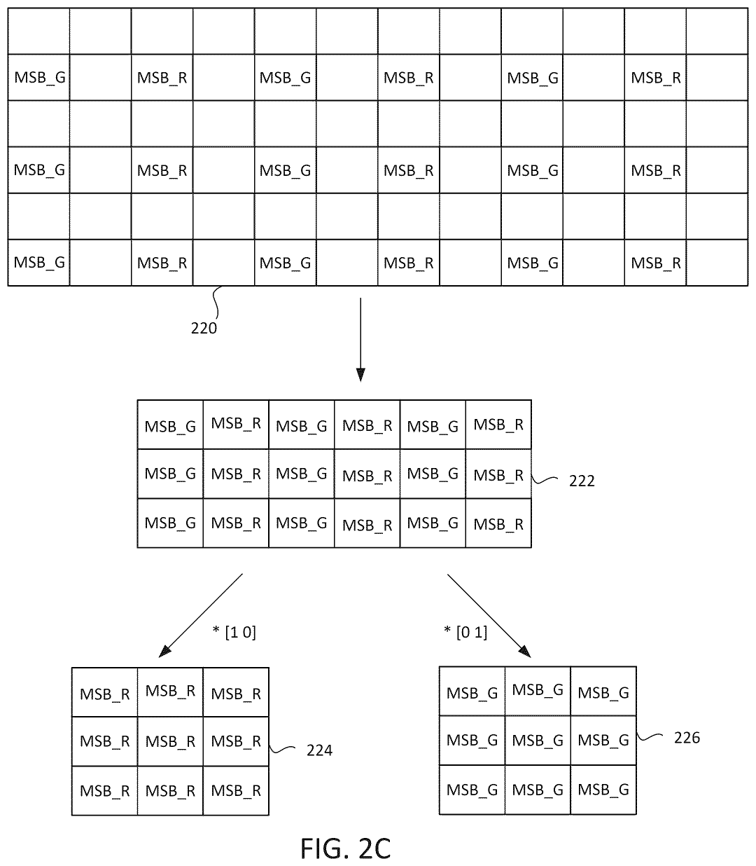

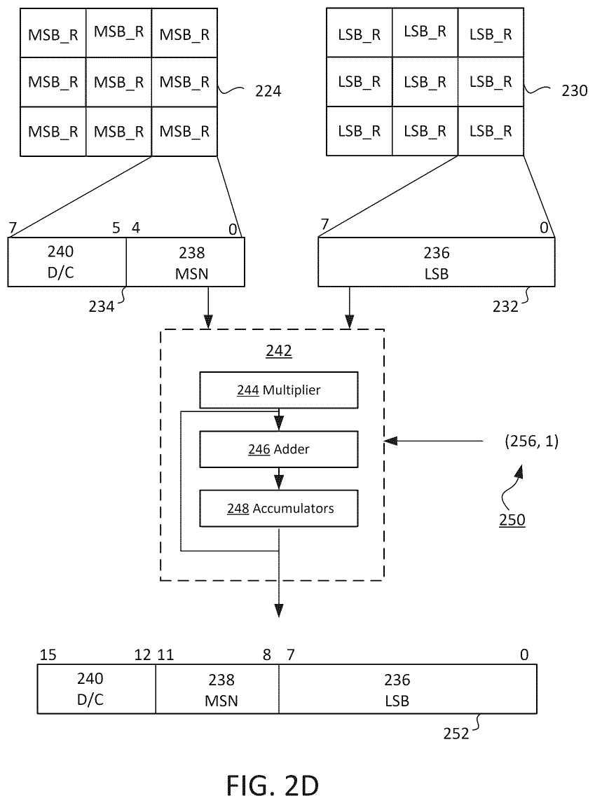

FIG. 2A illustrates an example of charge coupled device (CCD) sensor data 200, according to some embodiments. The CCD sensor data 200 is generated by an analog or digital sensor (e.g., sensors 170 of FIG. 1B), which a compute device (e.g., SD circuit(s) 150, SD chip(s) 152 of FIG. 1D) can analyze and determine an intensity according to various colors as received by one or more circuits of the compute device via a CCD sensor or any other type of image sensor (e.g., camera 170m of FIG. 1B). For example, a CCD sensor can be coupled with color filters for sensor regions, referred to as pixels 202 (e.g., a Bayer or other filter arrangement) to receive a magnitude of red, green, and blue light according to a predefined pattern. The intensity is discretized by a digital circuit of the circuits of the ego computing device 141 or another compute device. For example, each value may correspond to a fixed number of bits such as according to a ten-bit representation, twelve-bit representation, sixteen-bit representation, or so forth. A higher number of bits can correspond to increased data precision (e.g., lower discretization error). Information determinable based on the CCD sensor data 200, such as a location, intensity, color, or motion of an object may be useful for a perception system of a robot, autonomous vehicle, or other ego device 140. For example, a computing device of the ego device 140 can determine such information based on the CCD sensor data 200, in combination with a pose of the ego, or other information accessible to the computing device. However, the computing device (e.g., an autonomous vehicle) can be configured to process data according to a predefined format (e.g., a bit-mapped or other image data format 204), such as a series of pixels 202 (referring now to a red, green, and blue (RGB) pixel 202, distinct from the Bayer filter pixel 202 above) which each have an overall intensity value or separate intensity values for various colors.

In some instances, an image signal processor (ISP) can optionally apply data transforms to generate the image data format 204 from the CCD sensor data 200. A hardware-implemented ISP can be disposed within a pipeline to receive CCD sensor data 200 and output an image data format 204 based thereupon according to interpolation of RGB data between the pixels 202, and de-mosaicing according to operations such as noise reduction, image sharpening, etc. Such operations can operate on distinct color channels corresponding to the Bayer or other filter of the CCD sensor. For example, the ISP can generate a constituent red channel, blue channel, first green channel, and second green channel from the CCD sensor data 200, and thereafter perform operations from the color channels. However, such an ISP may be implemented according to a fixed-bit-width which may not provide a desired granularity or precision for a model of a neural network of a machine learning architecture (e.g., one or more of the AI models 110c, above). Accordingly, at least a portion of the ISP can be bypassed according to implementation of eth present disclosure. For example, a hardware pipeline may omit shift registers, adders, dividers, or other components to implement the interpolation, de-mosaicing, or other operations of the ISP. The pipeline may include components configured to implement binary conversion, such as multiplier-accumulators (MACs). The MACs may differ in bit-width from data elements of the CCD sensor data 200 or the image data format 204. For example, the MACs can be implemented as eight-bit MACs and the data elements can include twelve-bit or sixteen-bit data elements.

In further examples, the present disclosure can be implemented for devices of further bit-widths. For example, thirty-two or sixty-four bit input data can be convolved to generate various channel data using sixteen or thirty-two bit MACs, respectively. Further, combinations of further inputs can be combined (e.g., the sixty-four bit input can be convolved across eight eight-bit MACs). Such operations can use increased numbers of convolution stages.

Although several of the examples provided herein refer to an output as an integer multiple of an input, some outputs can be generated for non-integer inputs. For example, the twelve-bit output referred to above can be realized from the two eight-bit MAC inputs. Such non-integer mapping can correspond to dropping an unavailable carry bit or other low significance bit from an input MAC, or according to a truncation of available precision. For example, even where sixteen-bit precision data is available, lesser precision data can be provided as an output. Similarly, even output data can be provided with increased precision, relative to sensor data. For example, bit-padding can provide sixteen bit outputs including twelve most significant bits and four least significant padding bits.

According to an illustrative embodiment of the present disclosure, a convolutional engine 206 using components configured to implement binary conversion (e.g., MACs) can generate an image data format 204 from CCD sensor data 200. For example, the convolutional engine can generate color channels for further processing. Such an example should not be construed as limiting. Although many of the illustrative examples provided herein relate to color channel extraction, to maintain consistency of descriptive terms, such examples should not be construed as limiting. The techniques described relative to color channel extraction can be used to generate output channels of various other data types. According to further illustrative embodiments of the present disclosure, the convolutional engine 206 can generate output channels for various other data types, such as temporal or spatial dimension information (occupancy data related an occupancy grid) for a computer-vision system. A circuit including the convolutional engine 206 can generate outputs such as control signals to cause an autonomous vehicle to execute a navigational action, or cause a robotic system to execute maneuvers.

FIG. 2B illustrates an example data flow for an example data structure for multi-byte CCD sensor data 200, according to some embodiments. CCD sensor data 200 is shown according to mapped bytes, wherein each pixel 202 is depicted according to a most significant byte (MSB) 210 and a least significant byte (LSB) 212. Such an implementation can depict data of various precision levels. For example, for sixteen-bit data, each of the bits can provide precision; for twelve-bit data, a most significant nibble of the MSB 210 (or a least significant nibble of the LSB 212) can carry flags, zeros, or be provided as fixed or don't-care values. Although an appropriately sized ISP can include a module configured to receive the depicted data structure (e.g., as a serial data stream or series of register transfers) and generate output channels according to a predefined bit position, such a module may not be configured to operate according to a preferred bit-width. Accordingly, the convolutional engine 206 can generate various sets 216 of the input data for output, each set 216 having a portion of the data elements of the input data, by convolving a predefined kernel (e.g., two-by-two predefined kernels 214) with the input data (e.g., each two- by-two predefined kernel 214 can correspond one of the sets 216). For example, the depicted data structure can be deplaned into constituent planes via the predefined kernels 214.

An input of mosaic data can be filtered to generate separate channel data. For example, for an input data structure including sixteen-bit data elements, a byte-wise convolution with a predefined kernel 214 of

$$[ \begin{matrix}1 & 0 \\ 0 & 0\end{matrix} ]$$

(having bit values of 11111111, 00000000, 00000000, 00000000) can, according to a vertical and horizontal stride length of two (bytes), multiply every bit of an MSB 210 of blue channel data by 1, every bit of a LSB 212 of blue channel data by zero, half the MSB 210 of green channels (e.g., a first green channel) by one, and another half the MSB 210 of green channels (e.g., a second green channel) by zero. Transposed instances of the kernel, (e.g., other single-entry instances of a predefined two-by-two kernel 214,

$$[ \begin{matrix}0 & 1 \\ 0 & 0\end{matrix} ] , [ \begin{matrix}0 & 0 \\ 1 & 0\end{matrix} ] , and [ \begin{matrix}0 & 0 \\ 0 & 1\end{matrix} ] )$$

can generate three other of four planes. That is, the first plane can include a MSB 210 for a red and first green channel; the second plane can include a LSB 212 for the red and first green channel. The third plane can include a MSB 210 for a blue and second green channel; the fourth plane can include an LSB 212 for the blue and second green channel.

According to various embodiments or input data structures, different predefined kernels can be employed according to hardware functions available at a particular position within a pipeline (e.g., proximal to other components so as to avoid excessive latency). For example, some embodiments of the circuits are configured to convolve a four-by-2n kernel to generate four planes, each corresponding to a particular channel (e.g., a combination of MSB 210 and LSB 212 data or separate channels therefor). Such operation may obviate other operations described herein, such as a second convolution described henceforth. However, in some embodiments, hardware may not be available to implement such functionality, or may incur additional latency relative to the described examples.

FIG. 2C illustrates an example data flow for one set of data elements. For example, the input data elements can be a set 216 of data elements generated according to an output of the data flow of FIG. 2B. Similarly, the data flow can be repeated for other outputs of the data flow of FIG. 2B. Such operations can be performed serially or in parallel to generate channel information for each of the sets 216.

A first set 220 of data elements can include the depicted example of a sparse output lacking blue data, first channel green data, and the LSB of the red and second channel green data (corresponding to the zero values of the first predefined kernel). In some embodiments, the sparse structure may be de-sparsified, either upon generation or according to a subsequent operation. In some embodiments, the subsequent operation can be configured to selectively process a sparse data structure of the first set 220 of data elements (e.g., by dropping a lowermost bit of an address map, striding by two to ingest input data, intentionally overflowing or underflowing, or so forth). The de-sparsification can generate the depicted de-sparsified data structure 222, where the generation of the sets 216 is not already de-sparsified. That is, in some embodiments, such as where a data structure is natively generated as non-sparse, the de-sparsification is omitted.

Referring to “data elements” generally, the data elements of can include data elements of the CCD sensor data 200 or data elements of the set 220. When referring to data elements of the CCD sensor data 200, such a reference corresponds to a value which is represented by any number of bits. For example, according to the depicted examples, a data element can refer to the two-byte values. Likewise, referring to a data element of the 220 can also refer to greater than single byte data elements (e.g., ten-, twelve-, or sixteen-bit data), so that the MSB 210 or LSB 212 of such a data element is a portion of the data element itself. However, in some instances, it may be convenient to refer to the portions of the data elements themselves as “data elements.” For example, where a data structure includes an MSB 210 of a data element and lacks a corresponding LSB 212, it may be convenient to refer to the MSB 210 alone as a data element. For example, the first set 220 of “data elements” could also be referred to as a first set 220 of “data elements portions” without limiting effect.

One or more circuits of the compute device can generate further data structures from the first set 220. The generation of the further data structures is sometimes referred to as deplaning, as described above. That is, the generation of the first sets 216 of data elements from the CCD sensor data 200 may be referred to as a first deplaning, and the generation of further (e.g., constituent) data structures therefrom (also referred to as subsets) may be referred to as a second deplaning. Each of the first deplaning and the second deplaning may be performed according to a convolution implemented with MACs having a bit-width narrower than the data elements of the CCD sensor data 200 (e.g., the convolutions can be realized with eight-bit MACs for twelve- or sixteen-bit color data; sixteen-bit MACs for eighteen, twenty-four, thirty, or thirty-two bit color data).

For example, and with further reference to FIG. 2C, the second deplaning can be realized according to a convolution of further predefined kernels with the first set 220. The compute device can convolve a one-by-two (byte) kernel with the input data structure using the MACs, to provide deplaned data structures. More particularly, the second deplaning can deplane the red channel data from the green channel data in the depicted example, along with deplaning other mixed color channels from each other. For example, for an input data structure including sixteen-bit data elements, a convolution with a kernel of [0 1] (having bit values of 0000000011111111) can, according to a stride length of two (bytes), multiply every bit of a first of alternating bytes by 1 and every bit of second of alternating bytes (e.g., interstitial to or otherwise offset from the first alternating bytes) by zero, effectively generating a sparse output including green color channel data to the exclusion of red color channel data, or including red color channel data to the exclusion of green color channel data. Such an operation can be performed prior or subsequent to a de-sparsification of the first set 220. Executing the second deplaning subsequent to such a de-sparsification can substantially reduce the dimensionality of the convolution (e.g., the dimensionality difference between the set 220 and the depicted de-sparsified data structure 222, such that a one-by-two kennel can be used instead of an n-by-four kernel). However, executing the second deplaning operation prior to a contemplated de-sparsification may better align with component availability within a particular pipeline (e.g., a portion of a hardware pipeline which does not have ready access to an arithmetic logic unit supporting a rate of data ingestion).

References to the one-by-two kernel (corresponding to bit-augmented inputs of sixteen bits for eight-bit hardware) are not intended to be limiting. Indeed, various embodiments, can include differently sized kernels, such as a one-by four-kernel for bit-augmented inputs of sixty-four bits for sixteen-bit hardware or n×m kernels for data having a row organization of n and a column organization of m (e.g., for color data that spans rows). The computing device can select a stride to avoid overlap or stride gaps (sometimes referred to as underlap). For example, for the one-by-two kennels, the computing device can select a (vertical) stride of two and a step (sometimes referred as a horizontal stride) of one.

A transposed predefined kernel of [1 0] can likewise generate another output lacking transposed data (according to the transposed single entry in the predefined kernel). Thus, the generated data structures may be constituent data structures of the de-sparsified data structure 222 or the set 220. Such data structures can be referred to as subsets of data elements of the set 220. For example, the subsets include a red (MSB) subset 224 and first or second green (MSB) subset 226. As depicted, the subsets may be de-sparsified, either upon generation or a subsequent operation. Thus, the circuit can generate subsets of the sets 216 by convolving various second predefined kernels with each of the set 216, each of the second predefined kernels corresponding to one of the subsets.

Either of the first deplaning or the second deplaning can be performed prior to the other of the first deplaning or the second deplaning. For example, in some embodiments, the first deplaning can generate a MSB 210 and LSB 212 data structure, which can each thereafter be deplaned to generate constituent data structures thereof. According to a standard-Bayer filter input, such constituent data structures could include each of a red, blue, first green, and second green subset. That is, such structure could be identical to the depicted red (MSB) subset 224 and first or second green (MSB) subset 226, along with other instances to generate MSB 210 and LSB 212 subsets corresponding to each of a red channel, blue channel, first green channel, and second green channel. Once again, in various embodiments, these illustrative color channels can be substituted for occupancy or motion signifiers, temperature spectrums, or other data structures generated in accordance with the present disclosure.

Upon a generation of the subsets of data elements (e.g., the MSB 210 and LSB 212 thereof), the circuit can generate multiple channels (e.g., color channels). According to various instances or applications, each channel can include output data of one or more of the subsets. In some embodiments, a machine learning model (e.g., one or more layers thereof) is configured to operate according to a fixed combination of the sets or subsets. For example, a machine learning model can be configured to operate on a most significant bit or nibble at all times (e.g., a collision avoidance system can operate on an uppermost bit or nibble to detect gross object immediately in a vehicle path). Another model can operate on a least significant bit or nibble at all times (e.g., to detect subtle changes to an environment, such as to distinguish between rigid and elastic objects). Some models can support run-time precision switching, or mixed precision for various datasets (e.g., higher precision for a forward-facing camera, relative to a rear-facing camera). For example, an autonomous vehicle can operate at reduced precision in clear environments at low speeds where nearby objects are not detected, and switch to higher precision operation in inclement environments, at high speeds, or proximal to another vehicle, vulnerable road user, or so forth. Such determinations can be implemented according to other sensor data of other sensors coupled with the vehicle. The switched operation can reduce energy use or a thermal load that may extend a lifetime of electronic components or increase range of an electric vehicle. To generate the bit-augmented channels (e.g., channels including data elements exceeding one byte), the circuit can generate data structures including the MSB 210 and LSB 212 bytes (or other subsets according to other embodiments, such as a most and least significant sixteen-bit or thirty-two-bit word). To generate non-bit-augmented channels, the circuit can discard a portion (generally less significant bits) of the data elements and operate at a native resolution of a MAC or other circuit portion, or apply another convolutional data transform (e.g., to perform similar operations at a bit-level or nibble level).

FIG. 2D illustrates an example data flow for an example data structure for multi-byte CCD sensor data 200, according to some embodiments. An output word 252 for a data channel is generated according to the example data flow. For example, the output word 252 can describe a color level according to a bit-augmented precision, depicted particularly as a twelve-bit output for a red color channel. Inputs to the data flow include subset elements of a red (MSB) subset 224 and a red (LSB) subset 230. According to the depicted example, the red (LSB) subset 230 includes a first byte 232 of a LSB of red channel color information; the red (MSB) subset 224 includes a second byte 234 including four most significant bits (MSB) of a most significant nibble (MSN) 238 and four don't-care bits 240, zeros or ones, flags, padding, etc.

One or more multiplier-accumulators (MACs) 242 of a MAC array are configured to receive the first byte 232 and the second byte 234. For example, the MAC 242 can receive a first of a set of predefined weights 250 to left-shift the MSN 238 to bits 8:11 of the accumulator 248 or another output register (e.g., a multiplicand of 256 for a multiplier 244 of the MAC 242). The MAC 242 can receive a second of the set of predefined weights 250 to maintain a position of the LSB (e.g., a multiplicand of 1 for a multiplier 244 of the MAC 242). An adder 246 can sum the respective products to generate a bit augmented output in the accumulator 248. The bit augmented output can include a sixteen-bit output word including at least the LSB 236 from the first byte and the MSN 238 of the second byte. In some embodiments, the output can generate an output word 252 further including flags, don't care bits 240, or other data. In some embodiments, such information is lost according to the operation of the MAC 242 (e.g., where a data is stored according to a sign bit).

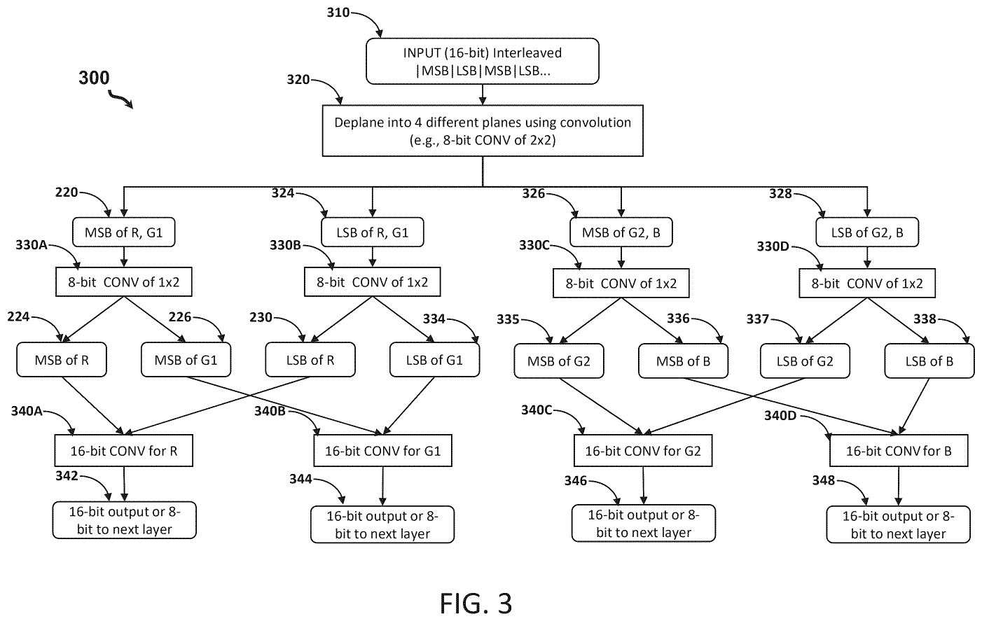

FIG. 3 illustrates an example of a data flow for a method 300 of channel extraction, according to some embodiments. For example, the method 300 can be executed to separate color channel data from an input image including two-byte color data without a separate ISP. At operation 310, an input data structure is obtained via a circuit of a compute device. The input data structure can include elements of a bit-width exceeding a bit-width of the circuit (e.g., a MAC 242 of a MAC array or ISP configured to process the received data). For example, the input data structure can include CCD sensor data 200 as depicted in FIG. 2A or FIG. 2B (e.g., the input data structure can include a CCD image as received via a Bayer filter). The input data structure can be received according to a serial stream or parallel transfer (e.g., register transfer). For example, the input data structure can be received according to a register transfer for a bit-width less than the bit- width of data elements in the data structure (e.g., an eight-bit bus for two-byte data).

At operation 320, the input data structure is deplaned into four constituent planes according to a two-by-two kernel. For example, the constituent data structures can be deplaned as is depicted in FIG. 2B to generate the example first set 220 of data elements depicted in FIG. 2C, along with a further second set 334 of data elements for which such data elements include the LSB 212 of the same channel data of the first set 220 (LSB 212 of red channel data and a green channel). Likewise, a third set of data elements 326 and fourth set of data elements 338 refer to sets including a respective MSB 210 and LSB 212 for green channel data of another green channel and blue channel data. The four planes may be generated serially or in parallel. Further, such a deplaning can occur prior or subsequent to another deplaning at operation 330 (referring, collectively, to operations 330a, 330b, 330c, and 330d) as described above with reference to FIG. 2C. That is, the first operation can deplane the input data structure into the four sets 220, 324, 326, 328 that are thereafter each deplaned into two constituent subsets, or first operation can deplane the input data structure into two sets that are each thereafter deplaned into four constituent subsets.

At operation 330a, the first set 220 of data elements is deplaned to generate the red (MSB) subset 224 and first green (MSB) subset 226. At operation 330b, the second set 324 is deplaned to generate the red (LSB) subset 230 and first green (LSB) subset 334. At operation 330c, the third set 326 is deplaned to generate the blue (MSB) subset 336 and second green (MSB) subset 335. At operation 330d, the fourth set 328 is deplaned to generate the blue (LSB) subset 338 and second green (LSB) subset 337.

At operation 340 (referring, collectively, to operations 340a, 340b, 340c, and 340d), the separate portions of data elements are combined as described above with reference to FIG. 2D to generate color channel data (e.g., according to the output word 252 of FIG. 2D). The generation can include fixed or variable bit-widths, such as for bit-augmented or non-bit-augmented operation. Particularly, at operation 340a, first channel data 342 corresponding to a red channel is generated. At operation 340b, second channel data 344 corresponding to a first green channel is generated. At operation 340c, third channel data 346 corresponding to a second green channel is generated. At operation 340d, fourth channel data 348 corresponding to a blue channel is generated.

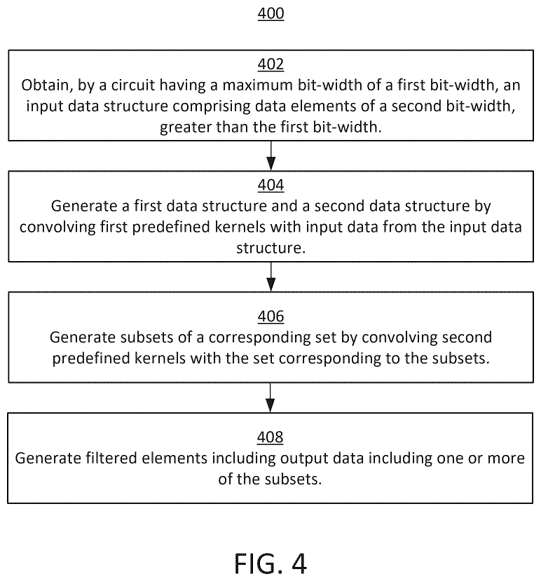

FIG. 4 illustrates an example of a method 400, according to some embodiments. The method 400 can be performed by a circuit for a first bit-width (e.g., comprising an array of eight-bit MACs 242).

At operation 402, the circuit obtains input data including multiple data elements having a second bit-width exceeding the first bit-width (e.g., receives two-byte data for a single-byte hardware circuit). The smaller of the bit widths can be constrained according to, for example, a data path, register width, select lines, or other components. For example, a sixteen-bit MAC operatively coupled with an eight-bit data bus input, or a sixteen-bit multiplier of a MAC including a twenty-four-bit accumulator can be referred to as having a lesser bit-width than a sixteen-bit MAC coupled with a sixteen-bit input data path and a thirty-two bit output data path. Such circuits can be referred to as having a maximum bit-width equal to a constrained data flow. For example, the sixteen-bit MAC operatively coupled with an eight-bit data bus input or an eight-bit MAC operatively coupled with an eight-bit data bus input can both be referred to as having a maximum bit-width of eight bits (e.g., the first bit-width in the example). In some embodiments, the input data represents spatial dimension information for a computer-vision system, and an output of the circuit is configured to generate control signals to execute a maneuver of a robotic system. In some embodiments, the circuit is further configured to obtain an indication of an identity of one of an operating condition or a component at the output of the MACs and select, based on the identity, the bit-width exceeding the first bit-width from various bit-widths, at least one of which does not exceed the first bit-width (e.g., can select standard or augmented bit-operation based on environmental factors or a hardware identifier, such that a same model can be implemented by multiple hardware configurations, such as according to a native mode in sixteen-bit hardware and a bit-augmented mode in eight-bit hardware).

At operation 404, the circuit generates multiple sets of the input data, each set having a portion of the data elements of the input data, by convolving multiple first predefined kernels with the input data. Each of the first predefined kernels can correspond to a separate one of the sets. For example, each of the first predefined kernels can be single entry kernels (e.g., for four two-by-two kernels). The single-entry kernels can generate a sparse set or other data structures herein. In some embodiments, the sets include a first set of the input data including a first portion of a first data element, the first portion corresponding to a first of the plurality of channels (e.g., a first portion of red, green, or blue data such as a MSB or LSB thereof).

The sets can further include a second set of the various sets of the input data including a second portion of the first data element, the first portion corresponding to the first of the plurality of channels, neither of the first portion nor the second portion of the first data element exceeding the second bit-width. In some embodiments, the first bit-width exceeds a sum of a third bit-width of the first portion of the first data element and a fourth bit-width of the second portion of the first data element. (e.g., each portion can be equal to or less than a bit-width of a MAC or other native hardware element of a pipeline).

At operation 406, the circuit generates, for each set, multiple subsets of the set by convolving multiple second predefined kernels with the set. Each of the second predefined kernels can correspond to a separate one of the subset. For example, each of the second predefined kernels can be single entry kernels (e.g., for two one-by-two kernels, a [0 1] kernel and a [1 0] kernel). In some embodiments, the sets of operation 404 include a first set of four data structures generated according to a convolution of the input data with four two-by-two single-entry kernels with a stride of two. The plurality of subsets of the present operation includes two data structures generated according to a convolution of a plurality of one-by-two single-entry kernels with the first set of four data structures.

At operation 408, the circuit generates channels (also refer to as channel data according to an output word). Each channel can include output data including data from one or more of the multiple subsets. For example, the channels can include color channels of an image obtained according to a Bayer filter (e.g., a red channel, a blue channel, and one or more green channels). In some embodiments, the circuit provides, to an output of various multiplier-accumulators (MACs), the color channels according to a bit width exceeding the first bit-width.

The depicted operations are not intended to be limiting. For example, and according to the various aspects of the present disclosure, operations can be omitted, added, substituted, or modified. For example, in some embodiments, the method 400 can include generating control signals to execute a navigational action based on information obtained via the channels (e.g., color channels). Such a navigational action can be by an autonomous vehicle, robot, or other device coupled with a compute device configured to execute the method 400, responsive to image data received by a sensor thereof. For example, the navigational action can cause a change to steering, acceleration, braking, driver alert, or an audible or visual indicator to other roadway occupants.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, attributes, or memory contents. Information, arguments, attributes, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-Ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
obtaining, by a circuit having a maximum bit-width of a first bit-width, input data comprising a plurality of data elements having a second bit-width exceeding the first bit-width;
generating, by the circuit, a plurality of sets of the input data having a portion of the data elements of the input data, by convolving a plurality of first predefined kernels with the input data, the plurality of first predefined kernels corresponding to the sets;
for the sets, generating, by the circuit, a plurality of subsets of a corresponding set by convolving a plurality of second predefined kernels with the set, the plurality of second predefined kernels corresponding to the subsets; and
generating a plurality of filtered elements, by the circuit, the filtered elements comprising output data comprising one or more of the plurality of subsets.

2. The method of claim 1, wherein the plurality of filtered elements are color channels of an image obtained according to a Bayer filter, the color channels comprising: a red channel, a blue channel, and a green channel.

3. The method of claim 2, wherein the image is obtained from a camera of a vehicle autonomous driving system, and the circuit is configured to generate control signals to execute a navigational action based on information obtained via the color channels.

4. The method of claim 2, further comprising providing, by the circuit to an output of a plurality of multiplier-accumulators (MACs), the color channels according to a bit width exceeding the first bit-width.

5. The method of claim 4, further comprising:
obtaining, by the circuit, an indication of an identity of one of an operating condition or a component at the output of the plurality of MACs; and
selecting, by the circuit based on the identity, the bit width exceeding the first bit-width from a plurality of bit-widths, at least one of the plurality of bit-widths not exceeding the first bit-width.

6. The method of claim 1, wherein:
a first set of the plurality of sets of the input data comprises a first portion of a first data element, the first portion corresponding to a first of the plurality of filtered elements; and
a second set of the plurality of sets of the input data comprises a second portion of the first data element, the first portion corresponding to the first of the plurality of filtered elements, neither of the first portion nor the second portion of the first data element exceeding the second bit-width.

7. The method of claim 6, wherein the second bit-width exceeds a sum of a third bit-width of the first portion of the first data element and a fourth bit-width of the second portion of the first data element.

8. The method of claim 1, wherein:
the plurality of first predefined kernels and the plurality of second predefined kernels are single-entry kernels; and
the plurality of sets comprise sparse data structures.

9. The method of claim 1, wherein:
the plurality of sets comprises a first set of four data structures generated according to a convolution of the input data with four two-by-two single-entry kernels with a stride of two; and
the plurality of subsets comprise two data structures generated according to a convolution of a plurality of one-by-two single-entry kernels with the first set of four data structures.

10. The method of claim 1, wherein the input data represents environmental information for a computer-vision system, and an output of the circuit is configured to generate control signals to execute a maneuver of a robotic system.

11. A system for arithmetic computation, the system comprising:
a circuit having a maximum bit-width of a first bit-width and configured to:
obtain input data comprising a plurality of data elements having a second bit-width exceeding the first bit-width;
generate a plurality of sets of the input data having a portion of the data elements of the input data, by convolving a plurality of first predefined kernels with the input data, the plurality of first predefined kernels corresponding to the sets;
for the sets, generate a plurality of subsets of a corresponding set by convolving a plurality of second predefined kernels with the set, the plurality of second predefined kernels corresponding to the subsets; and
generate a plurality of filtered elements comprising output data comprising one or more of the plurality of subsets.

12. The system of claim 11, wherein the plurality of filtered elements are color channels of an image, the circuit configured to obtain the image according to a Bayer filter, the color channels comprising: a red channel, a blue channel, and a green channel.

13. The system of claim 12, wherein the circuit is configured to:
obtain the image from a camera of a vehicle autonomous driving system; and
generate control signals to execute a navigational action based on information obtained via the color channels.

14. The system of claim 12, wherein the circuit is configured to provide, to an output of a plurality of multiplier-accumulators (MACs), the color channels according to a bit-width exceeding the first bit-width.

15. The system of claim 14, wherein the circuit is configured to:
obtain, by the circuit, an indication of an identity of one of an operating condition or a component at the output of the plurality of MACs; and
select, by the circuit based on the identity, the bit-width exceeding the first bit-width from a plurality of bit-widths, at least one of the plurality of bit-widths not exceeding the first bit-width.

16. The system of claim 11, wherein:
a first set of the plurality of sets of the input data comprises a first portion of a first data element, the first portion corresponding to a first of the plurality of filtered elements; and
a second set of the plurality of sets of the input data comprises a second portion of the first data element, the first portion corresponding to the first of the plurality of filtered elements, neither of the first portion nor the second portion of the first data element exceeding the second bit-width.

17. The system of claim 16, wherein the second bit-width exceeds a sum of a third bit-width of the first portion of the first data element and a fourth bit-width of the second portion of the first data element.

18. The system of claim 11, wherein:
the plurality of first predefined kernels and the plurality of second predefined kernels are single-entry kernels; and
the plurality of sets comprise sparse data structures.

19. An autonomous vehicle comprising:
one or more image sensors configured to generate an input data structure for image data, the input data structure having a plurality of data elements which exceed a first bit-width; and
a circuit having a maximum bit-width of a first bit-width, configured to:
obtain input data comprising the plurality of data elements having a second bit-width exceeding the first bit-width;
generate a plurality of sets of the input data having a portion of the data elements of the input data, by convolving a plurality of first predefined kernels with the input data, the plurality of first predefined kernels corresponding to the sets;
for the sets, generate a plurality of subsets of a corresponding set by convolving a plurality of second predefined kernels with the set, the plurality of second predefined kernels corresponding to the subsets; and
generate a plurality of filtered elements comprising output data comprising one or more of the plurality of subsets.

20. The autonomous vehicle of claim 19, wherein:
the plurality of filtered elements are color channels of an image; and
the autonomous vehicle is configured to generate control signals to execute a navigational action based on information obtained via the color channels.
